(19) United States
(12) Patent Application Publication
(10) Pub. No.: US 2011/0073449 A1
(43) Pub. Date: Mar. 31, 2011

(54) KEYBOARD

(75) Inventors: HUNG YEN, Tu-Cheng (TW); TE-HUA LEE, Tu-Cheng (TW); MAN-ZHONG WANG, Shenzhen City (CN); SHI-PEI ZHANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/610,382

(22) Filed: Nov. 2, 2009

(30) Foreign Application Priority Data
Sep. 25, 2009 (CN) 200920311388.1

(51) Int. Cl. H01H 9/00

(52) U.S. Cl. 200/314

(57) ABSTRACT

A keyboard includes a keypad portion, a base board, an illuminating device, and a circuit board. The keypad portion is mounted to the base board. The illuminating device is electrically connected to the circuit board and is further fixed to the base board surrounding the keypad portion. The circuit board is configured to supply the illuminating device with power. When powering the illuminating device, the keyboard can be used in a dark environment.

### BACKGROUND

1. Technical Field

The disclosure generally relates to keyboards, and particularly to a keyboard having an illuminating device.

2. Description of Related Art

Keyboards are usually an essential peripheral of an electronic device. An additional illuminating apparatus is needed to supply illumination when the keyboard is used in a dark environment. Therefore, what is needed is a keyboard having an illuminating device.

### BRIEF DESCRIPTION OF THE DRAWINGS

The components of the drawings are not necessarily drawn to scale, the emphasis instead being placed upon clearly illustrating the principles of the embodiments of a keyboard. Moreover, in the drawings, like reference numerals designate corresponding parts throughout several views.

FIG. 1 is a perspective view of a keyboard applied to an electronic device in accordance with one embodiment.

FIG. 2 is an exploded view of the keyboard of FIG. 1.

### DETAILED DESCRIPTION

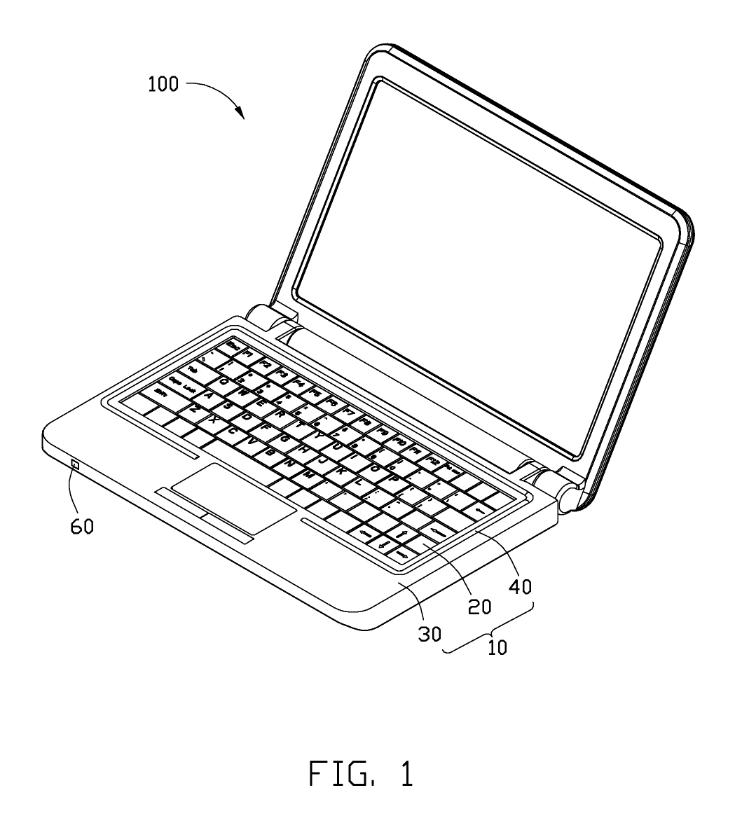

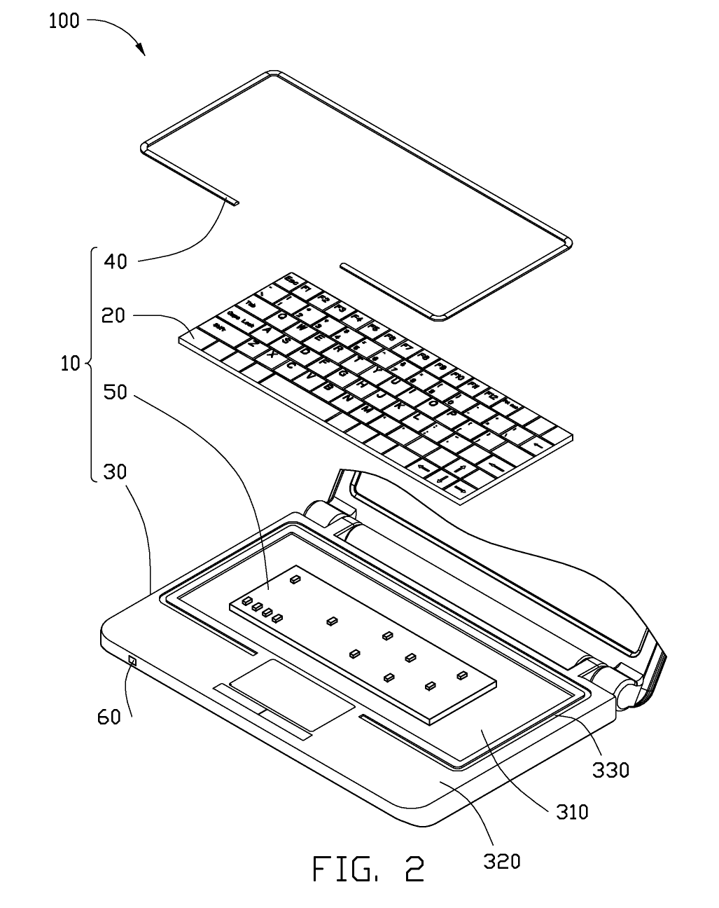

Referring to FIGS. 1-2, a keyboard 10 adopted by an electronic device 100 is shown. The keyboard 10 includes a keypad portion 20, a base board 30, an illuminating device 40, and a circuit board 50. The keypad portion 20 including a plurality of input keys is fixed to the base board 30 and is configured for receiving input operations. The illuminating device 40 is fixed to the base board 30 and surrounds the keypad portion 20. In the embodiment, the electronic device 100 is a notebook computer. The keyboard 10 is a laptop-size keyboard applied to the notebook computer. In other embodiments, the keyboard 10 can be a standard keyboard or a multimedia keyboard used in desktop computers.

The base board 30 includes an upper surface 320 defining a rectangular receiving space 310. The circuit board 50 is housed in the receiving space 310. The keypad portion 20 is received in the receiving space 310, covers and is electrically connected to the circuit board 50. A slot 330 is defined in the upper surface 310. The slot 330 is substantially rectangular and surrounds the receiving space 310. The illuminating device 40 is mounted in the slot 330 and is further electrically connected to the circuit board 50. In the embodiment, the illuminating device 40 includes a plurality of illuminating units, such as, LEDs (light-emitting diodes). In other embodiment, the illuminating device 40 is a flexible illuminating strip. The flexible illuminating strip is disposed substantially coplanar with respect to a top surface of the keypad portion 20. The circuit board 50 is further electrically connected to a power supply (not shown). The power supply is configured to supply the illuminating device 40 with power.

The keyboard 10 further includes a switch 60. In the embodiment, the switch 60 is mounted at a side surface of the base board 30. In other embodiments, the position of the switch 60 mounted at other locations on the keyboard 10. The illuminating device 40 is electrically connected to the circuit board 50 via the switch 60. the switch 60 controls power to the illuminating device 40.

In other embodiments, when the keyboard 10 is connected to an external processing system (not shown), for example, a personal computer. Power to the illuminating device 40 can be controlled via software drivers of the external processing system.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A keyboard, comprising:
a keypad portion;
a base board supporting the keypad portion;
a circuit board sandwiched between the keypad portion and the base board; and
an illuminating device fixed to the base board, the illuminating device being continuously extending along at least one side of the keypad portion, the illuminating device being electrically connected to the circuit board for receiving power from the circuit board, so as to illuminate the keypad portion.

2. The keyboard of claim 1, wherein a slot is defined in the base board, the slot substantially surrounds the keypad portion.

3. The keyboard of claim 2, wherein the slot is substantially rectangular.

4. The keyboard of claim 1, further comprising a switch, the illuminating device being electrically connected to the circuit board via the switch.

5. The keyboard of claim 1, wherein the keypad portion is electrically connected to the circuit board.

6. The keyboard of claim 1, wherein the illuminating device is a flexible illuminating strip, the flexible illuminating strip is disposed substantially coplanar with respect to a top surface of the keypad portion.

7. An electronic device, comprising:
a keyboard comprising:
a keypad portion;
a base board supporting the keypad portion;
a circuit board sandwiched between the keypad portion and the base board; and
an illuminating device fixed to the base board and substantially surrounding the keypad portion, the illuminating device being electrically connected to the circuit board for receiving power from the circuit board, so as to illuminate the keypad portion.

8. The keyboard of claim 7, wherein a slot is defined in the base board, the slot substantially surrounds the keypad portion.

9. The keyboard of claim 8, wherein the slot is substantially rectangular.

10. The keyboard of claim 7, further comprising a switch, the illuminating device being electrically connected to the circuit board via the switch.

11. The keyboard of claim 7, wherein the keypad portion is electrically connected to the circuit board.

12. The keyboard of claim 7, wherein the illuminating device is a flexible illuminating strip, the flexible illuminating strip is disposed substantially coplanar with respect to a top surface of the keypad portion.
